(19) United States
(12) Patent Application Publication
(10) Pub. No.: US 2017/0026590 A1
(43) Pub. Date: Jan. 26, 2017

(54) RGBZ PIXEL ARRAYS, IMAGING DEVICES, CONTROLLERS & METHODS

(71) Applicant: Samsung Electronics Co., Ltd., Suwon-si (KR)

(72) Inventors: Yibing Michelle WANG, Temple City, CA (US); Dong-Ki MIN, Seoul (KR); Ilia OVSIANNIKOV, Studio City, CA (US); Yoon-Dong PARK, Osan-si (KR)

(21) Appl. No.: 15/284,532

(22) Filed: Oct. 3, 2016

Related U.S. Application Data
(63) Continuation of application No. 13/901,564, filed on May 23, 2013.

(51) Int. Cl. H04N 5/341; H04N 5/376; G01S 17/89; H04N 9/04; H04N 5/225; G01S 7/481; H04N 13/02; H04N 5/369

(52) U.S. Cl. CPC H04N 5/341; H04N 13/0271; H04N 5/3765; H04N 5/3696; H04N 9/045; H04N 5/2256; G01S 7/4816; G01S 17/89; H04N 5/3532

(57) ABSTRACT

A pixel array includes color pixels that have a layout, and depth pixels having a layout that starts from the layout of the color pixels. Photodiodes of adjacent depth pixels can be joined to form larger depth pixels, while still efficiently exploiting the layout of the color pixels. Moreover, some embodiments are constructed so as to enable freeze-frame shutter operation of the pixel array.

### BACKGROUND

Many imaging applications are performed by solid-state imaging devices, which are formed on a semiconductor substrate. For many such applications, it is desirable to combine electronic color imaging with range finding in a single array of pixels. The combination would entail an array of pixels having both color pixels and depth pixels.

Referring to FIG. 1A, a diagram is shown of a kernel 100 of an imaging array in the prior art. Of course, it is understood that a full imaging array is made from many such kernels of pixels. FIG. 1A only shows kernel 100 because that is enough for explaining the problem in the prior art.

Kernel 100 incorporates color pixels, designated as R, G, or B, and a depth pixel, designated as Z. The color pixels generate an image in terms of three colors, namely Red, Green, and Blue. The depth pixel Z is used to receive light, from which the device determines its distance, or depth, from what is being imaged.

All these pixels work electronically. In addition, the electronic circuit arrangement for the color pixels is different from that for the depth pixel, as is explained below with reference to FIG. 1B and FIG. 1C.

FIG. 1B is an electronic schematic diagram 110 of two adjacent color pixels of the kernel of FIG. 1A, for colors C1, C2. In diagram 110, the two colors are shown as C1, C2 as an abstraction, for the fact that they each represent one of the colors R, G, B. The two pixels have respective photodiodes PD1, PD2, which are also sometimes called color photodiodes. A photodiode collects light and, in response, generates electrical charges. The two pixels also have respective transfer gates TX1, TX2. The two transfer gates can be made, for example, as Field Effect Transistors (FETs). The two transfer gates pass, one at a time, the generated electrical charges to a junction that is shown as capacitor 141.

The arrangement of diagram 110 is also called a 2-shared structure, where two photodiodes PD1, PD2, and two transfer gates TX1, TX2 share FET 142 as one source follower for output.

FIG. 1C is an electronic schematic diagram 120 of the depth pixel circuit of the kernel of FIG. 1A. The circuit of FIG. 1C has one photodiode PDZ with two transfer gates modulated by complementary clock signals CLK and CLKB, and two source followers for output. The determination of distance, or depth, can be made by using a Time-of-Flight (“TOF”) principle, where a camera that has the array also has a separate light source. The light source illuminates an object that is to be imaged, and the depth pixel Z captures a reflection of that illumination. The distance is determined from the total time of flight of that illumination, from the separate light source, to the object and back to the depth pixel.

Returning to FIG. 1A, it can be considered that, within kernel 100, not only are the circuits different for the color pixels than for the depth pixels; also, photodiode PDZ typically needs to be larger than photodiodes PD1, PD2 of the color pixels of FIG. 1B, for making the distance determination with acceptable accuracy in some situations.

A problem with kernel 100, and any imaging array made according to it, is with the photo response of the color RGB pixels. The photo response preferably is uniform for each pixel, but the arrangement of kernel 100 hinders that. The lack of uniformity in photo responses degrades the quality of the eventual rendered image. More particularly, the photo responses of color RGB pixels that neighbor depth pixel Z differs from those of the color RGB pixels that neighbor only color pixels. Worse, the photo responses of color RGB pixels that neighbor depth pixel Z differ from each other, depending on which part of the depth pixel Z they neighbor. These differences cause pixel-wise Fixed Pattern Noise (FPN).

Another solution in the art is in U.S. Pat. No. 7,781,811, which teaches a TOF pixel with three transfer gates, two charge storage locations and one charge drain. The two charge storage locations are associated with two of the transfer gates. The two charge storage locations are used to store time-of-flight phase information. The charge drain is associated with the third transfer gate, and is used for ambient light reduction.

In addition, a paper titled: “A CMOS Image Sensor Based on Unified Pixel Architecture with Time-Division Multiplexing Scheme for Color and Depth Image Acquisition”, IEEE Journal of Solid-Stage Circuits, vol. 47, No. 11, November 2012, teaches an imaging array being used for both color imaging and distance determination, using a time-division multiplexing scheme. The array is of uniform pixels, which wholly avoids the problem mentioned in FIG. 1A, namely the lack of uniformity in the photo response of the pixels. A different problem with such an arrangement, however, is that it could be hard to reduce the pixel pitch, and to increase the spatial resolution and the pixel fill factor.

### BRIEF SUMMARY

The present description gives instances of pixel arrays, imaging devices, controllers for imaging devices, and methods, the use of which may help overcome problems and limitations of the prior art.

In one embodiment, a pixel array includes color pixels that have a layout, and depth pixels having a layout that starts from the layout of the color pixels. Photodiodes of adjacent depth pixels can be joined to form larger depth pixels, while still efficiently exploiting the layout of the color pixels.

An advantage of an array made according to embodiments is that a high spatial resolution can be maintained, along with a high fill factor. In addition, the array can be configured in many different ways.

Another advantage over the prior art is that the photo response of the color pixels is more uniform, which reduces pixel-wise FPN, and therefore prevents image degradation. Another advantage is the greater ease in designing the layout, given the larger uniformity.

Moreover, some embodiments are constructed so as to enable freeze-frame shutter operation of the pixel array. An advantage is the reduction of motion and ambient light noise in depth imaging using the time-of-flight principle.

These and other features and advantages of this description will become more readily apparent from the following Detailed Description, which proceeds with reference to the drawings, in which:

### BRIEF DESCRIPTION OF THE DRAWINGS

FIG. 1A is a diagram of a kernel array in the prior art, which incorporates color pixels and a depth pixel.

FIG. 1B is an electronic schematic diagram of two adjacent color pixels of the kernel of FIG. 1A.

FIG. 1C is an electronic schematic diagram of the depth pixel circuit of the kernel of FIG. 1A.

FIG. 2 is a diagram of a kernel made according to a sample embodiment.

FIG. 3 is an electronic schematic diagram of a depth pixel such as the depth pixel of the kernel of FIG. 2.

FIG. 4 is a diagram of a kernel made according to another sample embodiment.

FIG. 5A is a diagram of a kernel made according to one more sample embodiment.

FIG. 5B is a diagram of a kernel made according to one more sample embodiment that is a variant of the kernel of FIG. 5A.

FIG. 6A is a table showing a set of possible values of clock signals for gating the transfer of charges within depth pixels according to embodiments.

FIG. 6B is a table showing another set of possible values of clock signals for gating the transfer of charges within depth pixels according to embodiments.

FIG. 7 is a diagram of a kernel made according to a sample embodiment.

FIG. 8A is a timing diagram for implementing a rolling shutter according to embodiments.

FIG. 8B is a timing diagram for implementing a global (“freeze-frame”) shutter according to embodiments.

FIG. 9 is a diagram of a kernel made according to a sample embodiment that uses freeze frame shutter.

FIG. 10 is a diagram of a kernel made according to another sample embodiment that uses freeze frame shutter.

FIG. 11 is a timing diagram of signals for controlling transfer gates to implement freeze frame shutter embodiments.

FIG. 12 is a flowchart for illustrating methods according to embodiments.

FIG. 13 depicts a controller-based system for an imaging device, which uses an imaging array made according to embodiments.

### DETAILED DESCRIPTION

As has been mentioned, the present description is about pixel arrays, imaging devices, controllers for imaging devices, and methods. Embodiments are now described in more detail. It will be understood from the many sample embodiments that the invention may be implemented in many different ways.

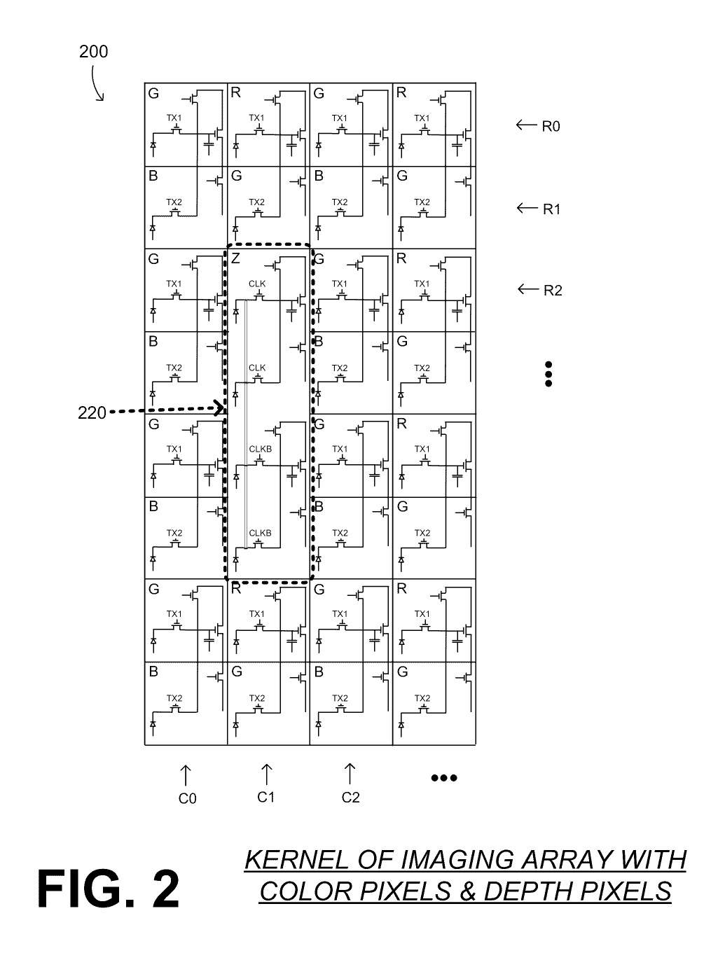

FIG. 2 is a diagram of a kernel 200 made according to a sample embodiment. Everything that is written about a kernel made according to an embodiment can also be said about an entire pixel array, as such could be made by repeating the kernel.

Kernel 200 has color pixels R, G, B, which define rows R0, R1, R2, . . . , and columns C0, C1, C2, . . . . Color pixels R, G, B, have components that are arranged according to a layout. The boundaries of the color pixels can define rectangles, or even squares, and any locations within the rectangles can be defined as locations according to the layout.

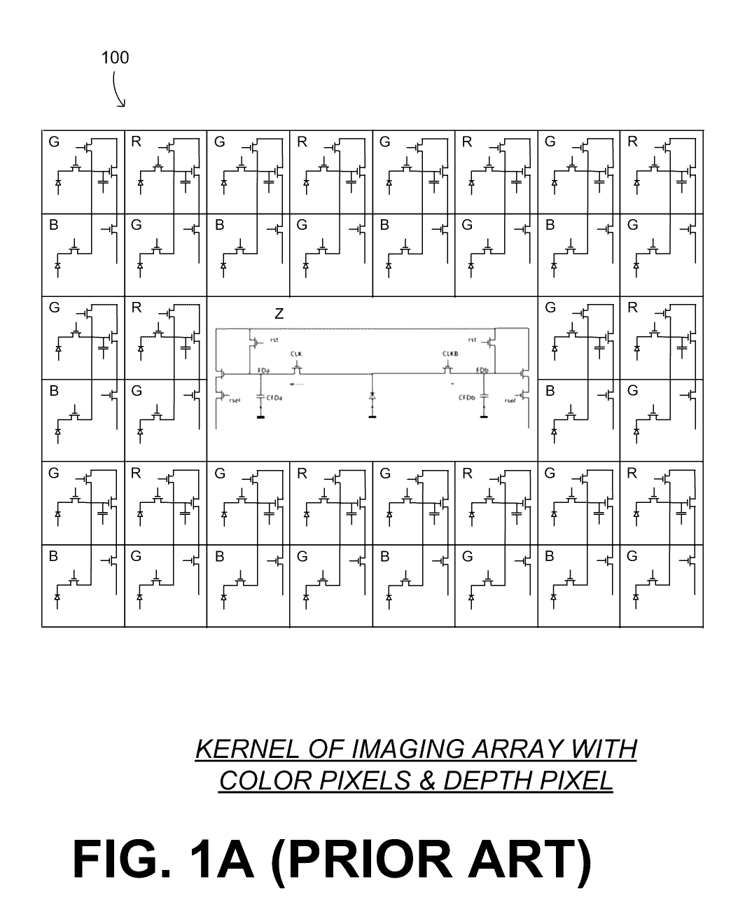

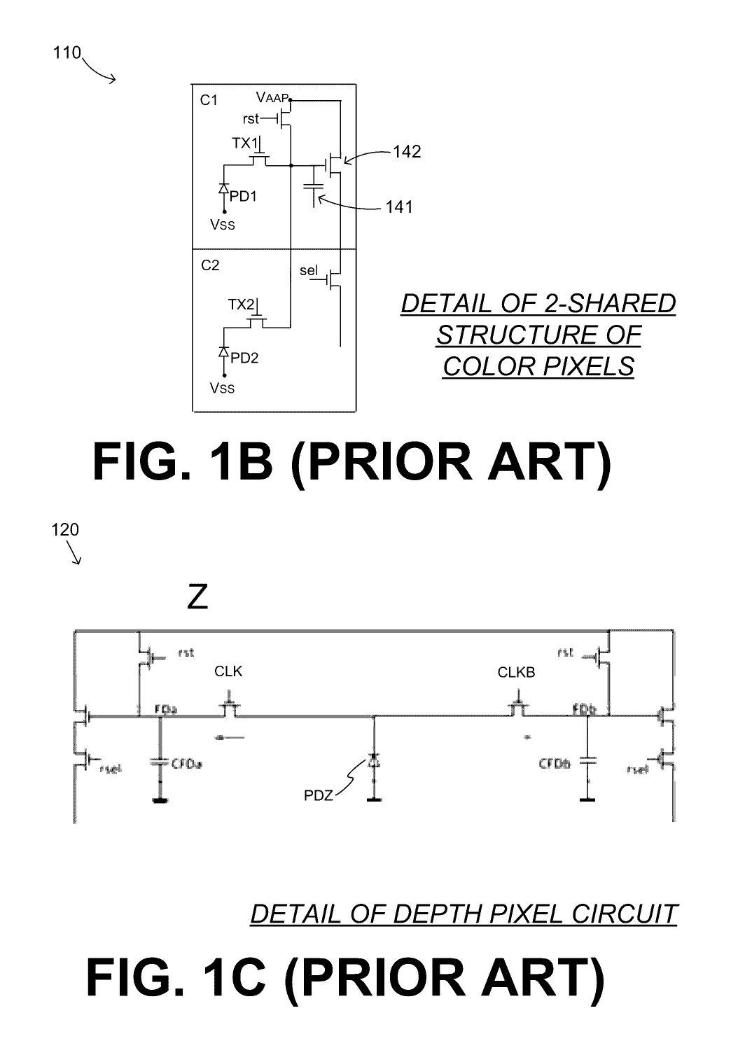

In kernel 200, color pixels R, G, B have photodiodes and transfer gates according to the layout. For example, color pixels R, G, B could be made as shown in FIG. 1B. In addition, they have other FETs, such as for Reset (rst), Select (sel or Rsel), and so on.

In kernel 200, color pixels R, G, B are arranged as to share a source follower for output according to a share structure. In this embodiment the color pixels are in a 2-shared structure, but that is only by way of example. The color pixels could alternately be in a non-shared structure, a 4-shared structure, an 8-shared structure, and so on.

Kernel 200 also has a depth pixel 220, while a full array would have multiple depth pixels. It might seem at first sight that pixel 220 is actually two, or even four pixels. Indeed, pixel 220 occupies as much space as four color pixels on either side of it. It will be explained later why pixel 220 is a single pixel. Regardless, for ease of consideration, sometimes a single depth pixel may be shown as divided according to some of the boundaries of the rows or the columns. Depth pixel 220 is now described in more detail.

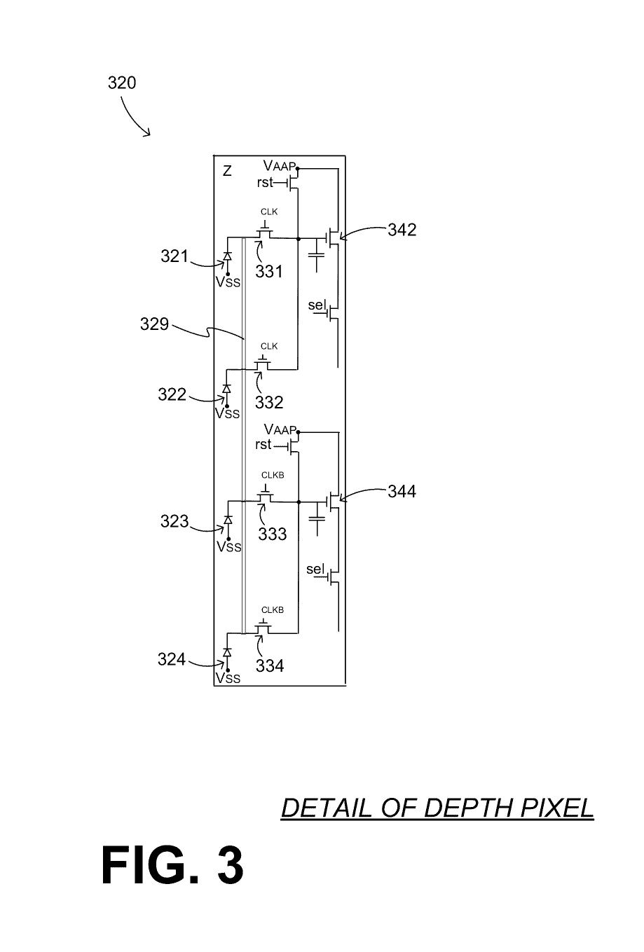

FIG. 3 is an electronic schematic diagram of a depth pixel 320, which can be for depth pixel 220. It will be instantly recognized that depth pixel 320 has been crafted by starting with the layout of four color cells.

To begin with, depth pixel 320 is shown with four photodiodes 321, 322, 323, 324 shown, which are also sometimes called depth photodiodes. Photodiodes 321, 322, 323, 324 are formed at least at locations similar, according to the layout, to locations of the color photodiodes.

In a further advantageous modification from the layout, two, or even more of these depth photodiodes further joined together. Of course, when the depth pixels are formed in a semiconductor substrate, photodiodes 321, 322, 323, 324 can be joined by extending a pn junction between the locations of photodiodes 321, 322, 323, 324, and further using a diffusion layer 329 in the substrate. When such joining is actually implemented, more of the top surface of the array becomes a pn junction that otherwise would not be, and the efficiency is increased. As such, when joined, photodiodes 321, 322, 323, 324 stop being separate devices by being merged together, and become a single actual depth photodiode.

Depth pixel 320 also includes four transfer gates 331, 332, 333, 334. These transfer gates are at locations similar, according to the layout, to locations of the transfer gates of the color pixels, as can be verified with a quick reference to FIG. 2. Transfer gates 331, 332, 333, 334 are respectively coupled to photodiodes 321, 322, 323, 324. If these photodiodes have been joined, there can still be four distinct transfer gates 331, 332, 333, 334 coupled to a single photodiode. In some instances, some of these transfer gates might not be used.

In addition, two transfer gates 331, 332 share a source follower 342 for output according to the 2-shared structure. Plus, the other two transfer gates 333, 334 similarly share a source follower 344.

Moreover, depth pixel 320, and also 220, can have FETs at every location similar, according to the layout, to locations of the FETs of the color pixels. For example, this can apply to FETs for Reset (rst), Select (sel), and so on.

The above preliminary examples described details of electrical connections and the like. Other examples are now presented, for how the color pixel layout can be used for crafting different depth pixels. It will be appreciated that, for different depth pixels, the charge generated by one of the depth photodiodes can be configured to be output from two or more different columns.

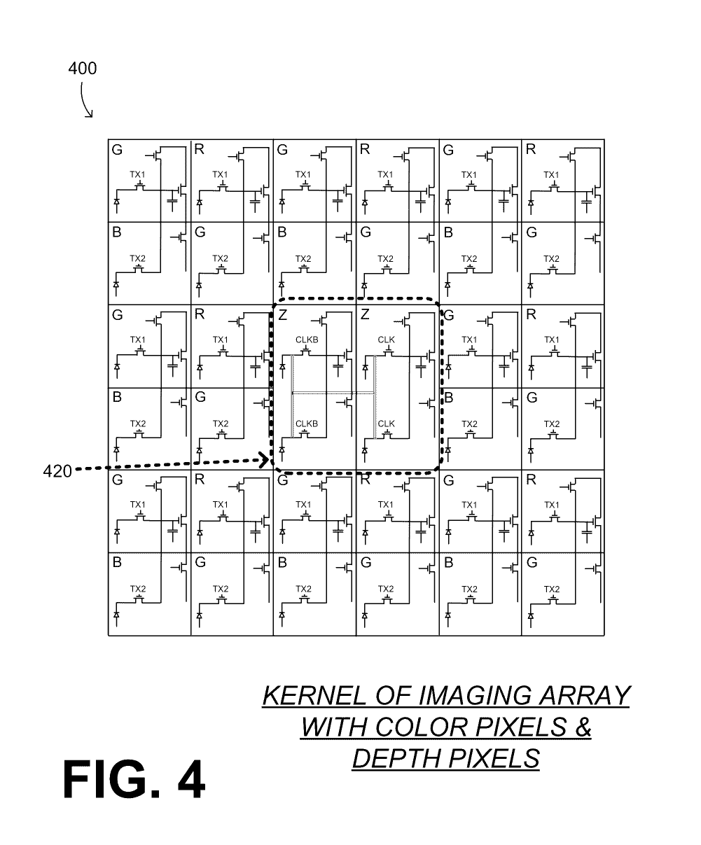

FIG. 4 is a diagram of a kernel 400 made according to another sample embodiment. Kernel 400 includes a depth pixel 420 in the space of four color pixels. Depth pixel 420 can be regarded, strictly speaking, as a single pixel, since all its photodiodes are joined, such as was described above. The photodiodes receive light, such as from a modulated light source and also ambient light, and generate charges such as electrons. It is preferred to have at least four photodiodes thus combined for the depth pixel.

Depth pixel 420 has four transfer gates, two controlled by clock signal CLK, and the other two by CLKB, which can be complementary to CLK. When CLK is high, electrons generated from the photodiodes flow to one of the floating diffusion regions; when CLKB is high, they flow to the other. At the end of integration, the charges accumulated onto these floating diffusion regions can be read out as signals, to ultimately assist with the depth calculation.

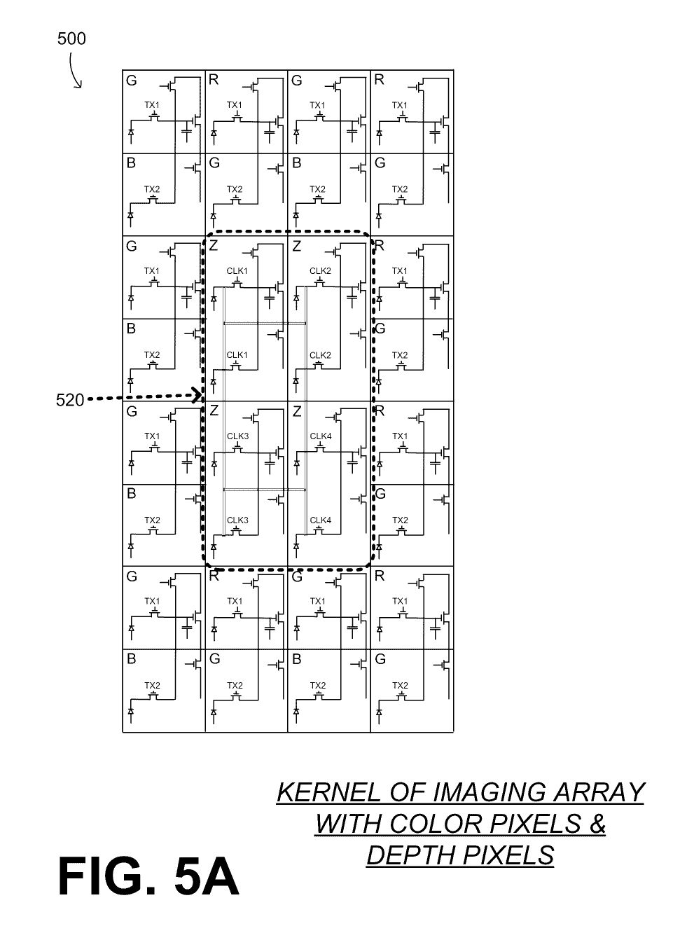

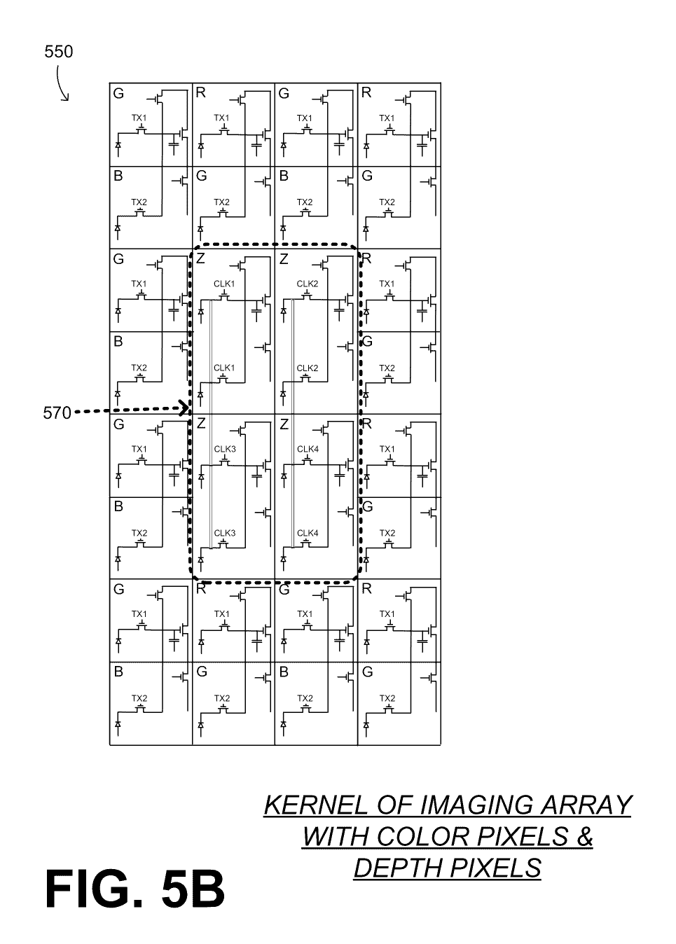

FIG. 5A is a diagram of a kernel 500 made according to one more sample embodiment. Kernel 500 includes a depth pixel 520 in the space of eight color pixels. Depth pixel 520 can be regarded, strictly speaking, as a single pixel, since all its photodiodes are joined. Still, there are eight transfer gates, two controlled by clock signal CLK1, two by CLK2, two by CLK3 and two by CLK4, and which will be described later.

FIG. 5B is a diagram of a kernel 550 made according to one more sample embodiment that is a variant of the kernel of FIG. 5A. Kernel 550 includes two depth pixels 570 in the space of eight color pixels. The two depth pixels 570 are defined, strictly speaking, from the two groups of four, according to how their photodiodes are joined. Still, there are eight transfer gates, two controlled by clock signal CLK1, two by CLK2, two by CLK3 and two by CLK4.

It will be observed that pixels 570 of kernel 550 produce two outputs for depth in two columns. In such embodiments, the outputs can be binned, i.e. combined for computing a value for the depth. The outputs can be added as charges, or as analog signals. Alternately, they can be converted to digital signals by an Analog to Digital Converter (ADC), and then added as digital signals.

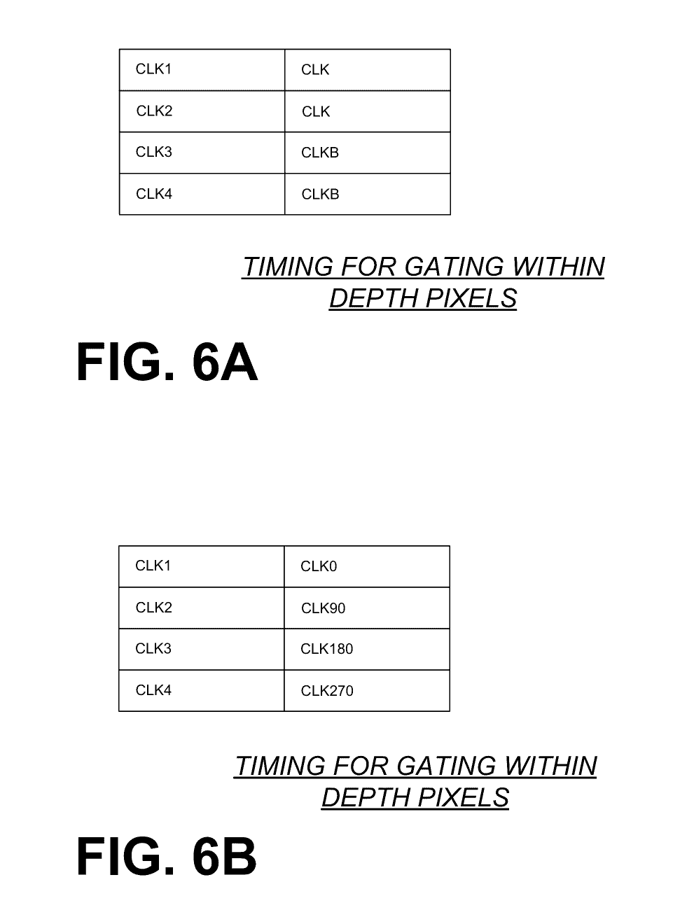

The transfer gates of the depth pixels can be controlled by clock signals. Options are now described. FIG. 6A is a table showing a set of possible values of clock signals CLK1, CLK2, CLK3, CLK4. The two clock signals CLK and CLKB do not open the transfer gates concurrently—rather they are complementary as described above. FIG. 6B is a table showing another such set of possible values, where the four transfer gates are opened non-concurrently. In the particular case of FIG. 6B, the four clock signals can have a 90 degree phase shift from each other, which enables a specific type of estimation of depth. They can implement a variety of different patterns, such as was described in US20110129123, which is hereby incorporated by reference. One of the patterns can be a phase mosaic.

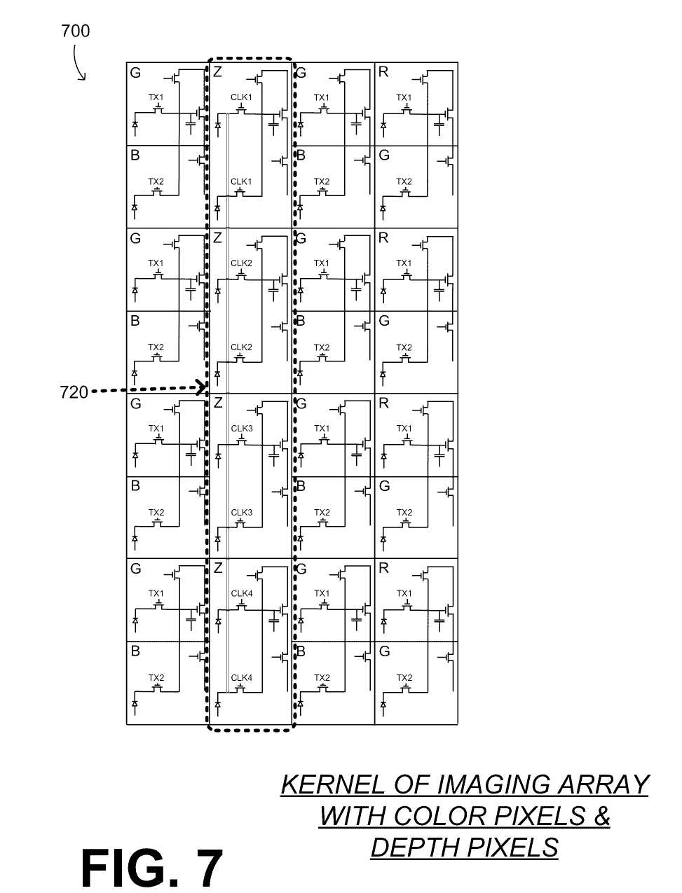

FIG. 7 is a diagram of a kernel 700 made according to a sample embodiment. Kernel 700 includes a depth pixel 720 in the space of eight color pixels. Depth pixel 720 can be regarded as a single pixel, since all its photodiodes are joined. Depth pixel 720 may result in improved color quality. There are eight transfer gates, two controlled by clock signal CLK1, two by CLK2, two by CLK3 and two by CLK4, as described above.

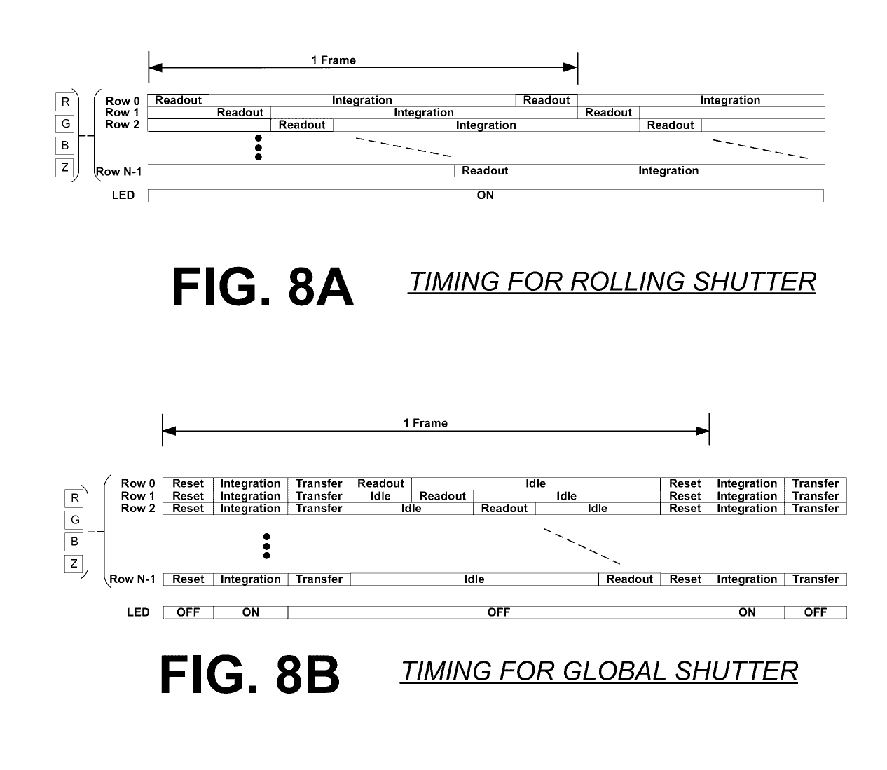

FIG. 8A is a timing diagram for implementing a rolling shutter operation of a pixel array according to embodiments, which can be applied to color (R, G, B) and depth (Z) pixels separately or concurrently. The timing diagram applies to the entire array, and not just to the sample kernels. Problems with the rolling shutter operation include motion blur, and ambient light noise in depth imaging using the TOF principle. Both problems can be reduced by implementing freeze-frame”) shutter operation, described below.

FIG. 8B is a timing diagram for implementing a global (“freeze-frame”) shutter operation of a pixel array according to embodiments, which therefore includes concurrently operating R, G, B and Z pixels. Motion blur is reduced by integrating all pixels at the same time period. The ambient light component of the noise can be reduced by using a higher-intensity light source, and shortening the integration time accordingly. Moreover, a high frame rate can be achieved this way.

For implementing a freeze-frame shutter operation, some modifications may be appropriate. The modifications may include which signals are used control some of the transfer gates of the depth pixels, and the timing relationships of these signals. Embodiments are now described.

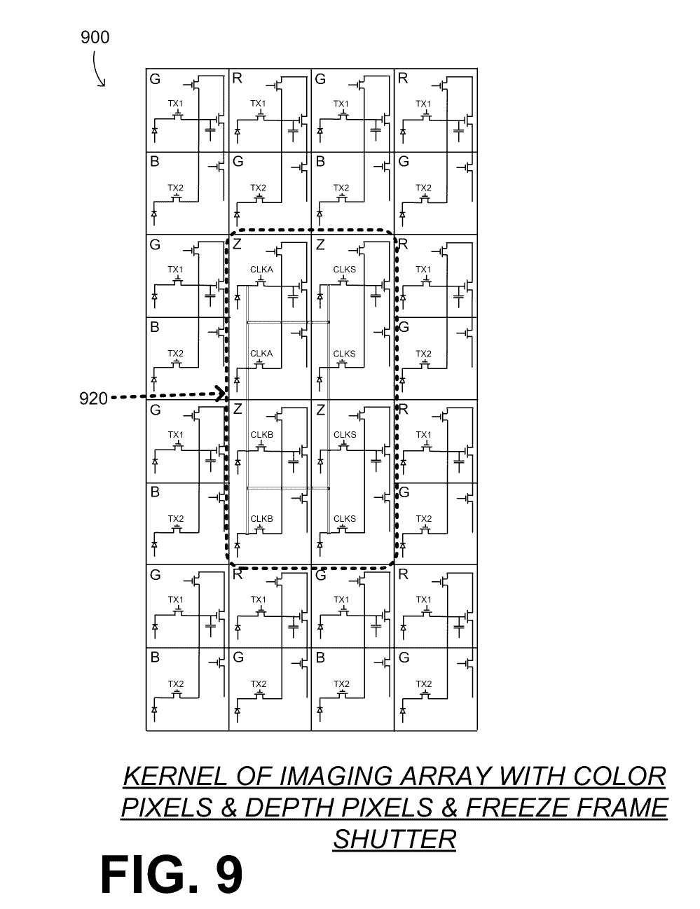

FIG. 9 is a diagram of a kernel 900 made according to a sample embodiment that uses freeze frame shutter for depth (Z) pixels. Kernel 900 includes a depth pixel 920 in the space of eight color pixels. There are eight transfer gates, two controlled by clock signal CLKA, two by CLKB, and the remaining four by CLKS, as will be described below.

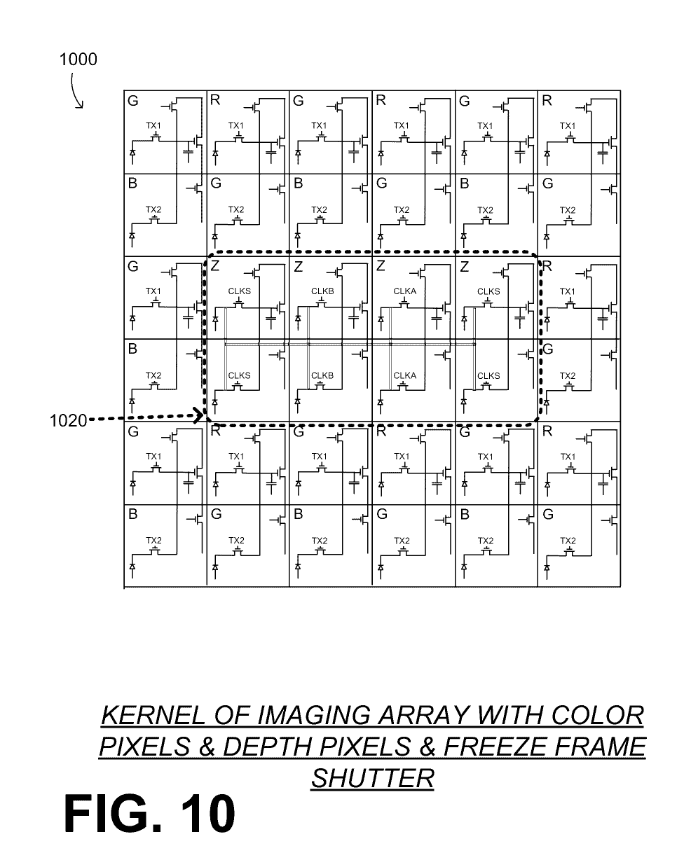

FIG. 10 is a diagram of a kernel 1000 made according to another sample embodiment that uses freeze frame shutter. Kernel 1000 includes a depth pixel 1020 in the space of eight color pixels. There are eight transfer gates, two controlled by clock signal CLKA, two by CLKB, and the remaining four by CLKS, as is now described.

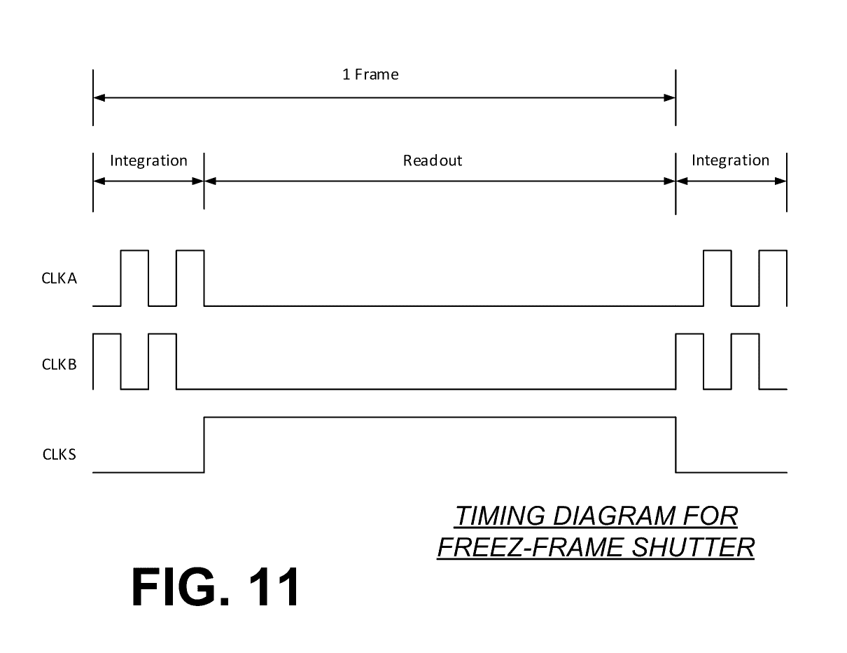

FIG. 11 is a timing diagram of signals for controlling transfer gates to implement freeze frame shutter embodiments, such as those of FIG. 9 and FIG. 10. FIG. 11 can be understood with reference also to FIG. 8B. FIG. 11 shows the relative timing of signals CLKA, CLKB and CLKS. This is an instance where three transfer gates of depth pixels are opened non-concurrently. While CLKA and CLKB are toggling, the pixels are in the integration phase, and the electrons generated by the modulated light and the ambient light flow to the two floating diffusion regions adjacent the transfer gates receiving the CLKA, CLKB signals. While CLKA and CLKB are idle, CLKS is high. The electrons generated by the ambient light component will flow to the other two floating diffusion regions. With this timing diagram, both freeze frame shutter operation and ambient light noise reduction can be realized.

In an alternative embodiment, in FIG. 10, the CLKS signals can be disabled, and each of those transfer gates does not receive a signal that changes its conductive state. This can be true also for other designs according to embodiments.

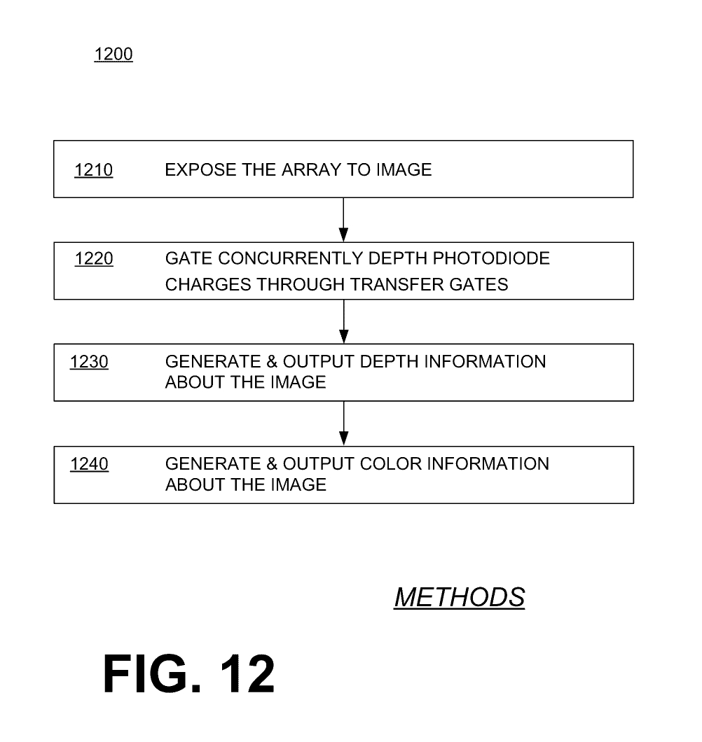

FIG. 12 shows a flowchart 1200 for describing a method. The method of flowchart 1200 is intended for an imaging device, and may also be practiced by embodiments described above. It will be appreciated that the method of flowchart 1200 is intended for sequential readout, in which color image is read after depth image.

According to an operation 1210, an array is exposed to an image, so as to cause a depth photodiode in the array to emit charges. The charges can be negative, such as electrons, or positive, such as holes.

According to a next operation 1220, the charges emitted from the depth photodiode are gated concurrently through the transfer gates. Concurrent gating can be implemented in a number of ways, such as by driving two transfer gates with the same CLK signal.

According to a next operation 1230, depth information about the image is generated from the gated charges, and output.

According to an optional next operation 1240, color information is generated about the image responsive to the exposure, and the color information is output.

In some embodiments, the depth pixel produces outputs in two different columns, and the outputs are binned.

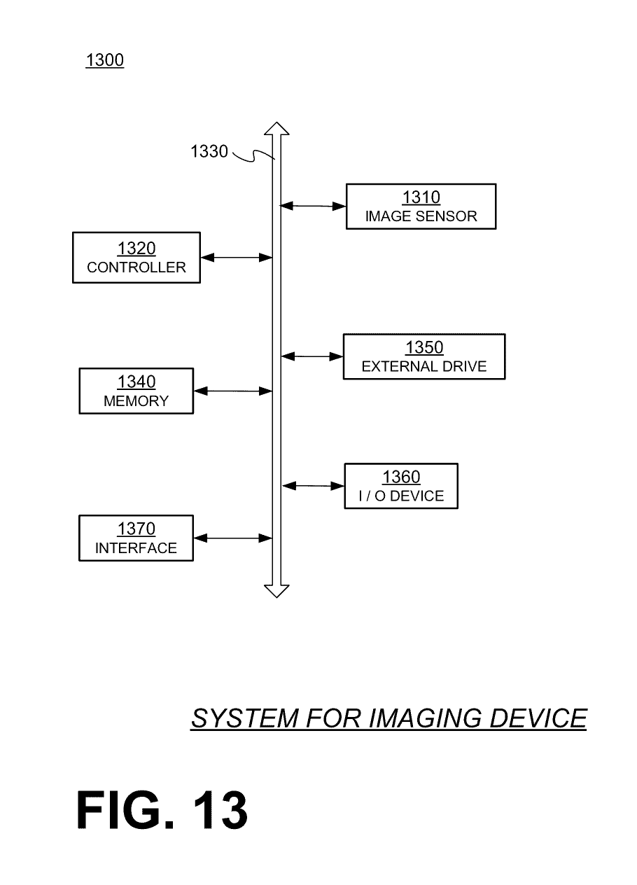

FIG. 13 depicts a controller-based system 1300 for an imaging device made according to embodiments. System 1300 includes an image sensor 1310, which is made according to embodiments. As such, system 1300 could be, without limitation, a computer system, an imaging device, a camera system, a scanner, a machine vision system, a vehicle navigation system, a smart telephone, a video telephone, a personal digital assistant (PDA), a mobile computer, a surveillance system, an auto focus system, a star tracker system, a motion detection system, an image stabilization system, a data compression system for high-definition television, and so on.

System 1300 further includes a controller 1320, which could be a CPU, a digital signal processor, a microprocessor, a microcontroller, an application-specific integrated circuit (ASIC), a programmable logic device (PLD), and so on. In some embodiments, controller 1320 communicates, over bus 1330, with image sensor 1310. In some embodiments, controller 1320 may be combined with image sensor 1310 in a single integrated circuit. Controller 1320 controls and operates image sensor 1310, by transmitting control signals from output ports, and so on, as will be understood by those skilled in the art.

Image sensor 1310 can be an array as described above. A number of support components can be part of either image sensor 1310, or of controller 1320. Support components can include a row driver, a clock signal generator and an Analog to Digital Converter (ADC). For the range finding portion, additional support components can be a distance information deciding unit and, if necessary, an interpolation unit.

Controller 1320 may further communicate with other devices in system 1300. One such other device could be a memory 1340, which could be a Random Access Memory (RAM) or a Read Only Memory (ROM). Memory 1340 may be configured to store instructions to be read and executed by controller 1320.

Another such device could be an external drive 1350, which can be a compact disk (CD) drive, a thumb drive, and so on. One more such device could be an input/output (I/O) device 1360 for a user, such as a keypad, a keyboard, and a display. Memory 1340 may be configured to store user data that is accessible to a user via the I/O device 1360.

An additional such device could be an interface 1370. System 1300 may use interface 1370 to transmit data to or receive data from a communication network. The transmission can be via wires, for example via cables, or USB interface. Alternately, the communication network can be wireless, and interface 1370 can be wireless and include, for example, an antenna, a wireless transceiver and so on. The communication interface protocol can be that of a communication system such as CDMA, GSM, NADC, E-TDMA, WCDMA, CDMA2000, Wi-Fi, Muni Wi-Fi, Bluetooth, DECT, Wireless USB, Flash-OFDM, IEEE 802.20, GPRS, iBurst, WiBro, WiMAX, WiMAX-Advanced, UMTS-TDD, HSPA, EVDO, LTE-Advanced, MMDS, and so on.

As mentioned above, controller 1320 may further support operations of the array. For example, the controller can have output ports for outputting control signals for, among other things, gating the transfer of changes from the depth photodiodes.

For implementing the signals of FIG. 11, for example, controller 1320 can output three signals CLKA, CLKB, and CLKS. As above, CLKA can toggle on and off with CLKB while CLKS is off, and CLKA and CLKB can be off while CLKS is on.

A person skilled in the art will be able to practice the present invention in view of this description, which is to be taken as a whole. Details have been included to provide a thorough understanding. In other instances, well-known aspects have not been described, in order to not obscure unnecessarily the present invention.

This description includes one or more examples, but that does not limit how the invention may be practiced. Indeed, examples or embodiments of the invention may be practiced according to what is described, or yet differently, and also in conjunction with other present or future technologies. For example, while flowchart 1200 illustrated sequential readout, concurrent readout is equivalently possible. Such would be implemented by using two readout paths, one for color images and one for depth images.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “computer-readable media” includes computer-storage media. For example, computer-storage media may include, but are not limited to, magnetic storage devices (e.g., hard disk, floppy disk, and magnetic strips), optical disks (e.g., compact disk [CD] and digital versatile disk [DVD]), smart cards, flash memory devices (e.g., thumb drive, stick, key drive, and SD cards), and volatile and nonvolatile memory (e.g., RAM and ROM).

The following claims define certain combinations and subcombinations of elements, features and steps or operations, which are regarded as novel and non-obvious. Additional claims for other such combinations and subcombinations may be presented in this or a related document.

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

What is claimed is:

1. A pixel array, comprising:
color pixels configured to generate color information of an object, the color pixels including a red pixel, a green pixel and a blue pixel; and
a depth pixel configured to generate depth information of the object, wherein the red pixel is connected to a color pixel floating diffusion region through a red pixel transfer gate, the green pixel is connected to the color pixel floating diffusion region through a green pixel transfer gate and the blue pixel is connected to the color pixel floating diffusion region through a blue pixel transfer gate, and
wherein the depth pixel is configured to generate the depth information based on total time of flight between emission of illumination from a light source and reception of the illumination upon the depth pixel.

2. The pixel array of claim 1, wherein the green pixel transfer gate and the red pixel transfer gate are turned on at different times from each other.

3. The pixel array of claim 2, wherein the depth pixel is connected to a depth pixel floating diffusion region through a depth pixel transfer gate.

4. The pixel array of claim 3, wherein electrons accumulated onto the color pixel floating diffusion region and electrons accumulated onto the depth pixel floating diffusion region are read out at different times from each other.

5. The pixel array of claim 4, wherein the red, green and blue pixels are connected to a color pixel reset gate and a color pixel source follower.

6. The pixel array of claim 5, wherein the depth pixel is surrounded by the red pixel, the green pixel, the blue pixel and another depth pixel.

7. The pixel array of claim 5, wherein the depth pixel includes a first depth photodiode and a second depth photodiode, and
wherein the first and the second depth photodiodes are connected to the depth pixel floating diffusion region a depth pixel source follower.

8. A pixel array, comprising:
color pixels configured to generate color information of an object, the color pixels including a red pixel, a green pixel and a blue pixel; and
depth pixels configured to generate depth information of the object, wherein the red, green and blue pixels are connected to a color pixel reset gate through a color pixel floating diffusion region, and
wherein depth pixels are configured to receive four clock signals and configured to generate the depth information in response to the received four clock signals.

9. The pixel array of claim 8, wherein the four clock signals include a first clock signal, a 90 degree phase-shift clock signal from the first clock signal, a 180 degree phase-shift clock signal from the first clock signal and a 270 degree phase-shift clock signal from the first clock signal.

10. The pixel array of claim 9, wherein the depth pixels are configured to receive the four clock signals at different times from each other.

11. The pixel array of claim 8, wherein the color information and the depth information are generated at different times from each other.

12. The pixel array of claim 11, wherein the depth pixel is surrounded by the red pixel, the green pixel, the blue pixel and another depth pixel.

13. A pixel array, comprising:
color pixels configured to generate color information, the color pixels including a red pixel, a green pixel and a blue pixel; and
a depth pixel configured to generate depth information, the depth pixel comprising a first depth photodiode and a second depth photodiode,
wherein the first depth photodiode and the second depth photodiode are connected to a depth pixel source follower though a depth pixel floating diffusion region.

14. The pixel array of claim 13, wherein the red pixel includes a red pixel photodiode and the green pixel includes a green pixel photodiode, and
wherein the red pixel and green pixel photodiodes are connected to a color pixel source follower though a color pixel floating diffusion region.

15. The pixel array of claim 13, wherein the depth pixel is configured to generate the depth information based on total time of flight between emission of illumination from a light source and reception of the illumination upon the depth pixel.

16. The pixel array of claim 13, wherein electrons accumulated onto a color pixel floating diffusion region and electrons accumulated onto the depth pixel floating diffusion region are read out at different times from each other.

17. The pixel array of claim 13, wherein the blue pixel includes a blue pixel photodiode, and
wherein the green pixel, red pixel and blue pixel photodiodes are connected to a color pixel source follower though a color pixel floating diffusion region.

18. The pixel array of claim 15, wherein electrons accumulated onto the red pixel photodiode and electrons accumulated on the green pixel photodiode are transferred to a color pixel floating diffusion region at different times from each other.

19. The pixel array of claim 15, wherein electrons accumulated onto the first depth pixel photodiode and electrons accumulated on the second depth pixel photodiode are transferred to the depth pixel floating diffusion region at the same time.

20. The pixel array of claim 15, wherein the depth pixel is surrounded by the red, green, blue pixels and another depth pixel.
